(19) United States
(12) Patent Application Publication
(10) Pub. No.: US 2010/0034420 A1
(43) Pub. Date: Feb. 11, 2010

(54) SYSTEM AND METHOD FOR VIDEO BASED FIRE DETECTION

(75) Inventors: Ziyou Xiong, Wethersfield, CT (US); Pei-Yuan Peng, Ellington, CT (US); Alan Matthew Finn, Hebron, CT (US); Muhidin A. Lelic, Manohester, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UTC Fire & Security Corporation, Framington, CT (US)

(21) Appl. No.: 12/448,961

(22) PCT Filed: Jan. 16, 2007
(86) PCT No.: PCT/US07/01079

§ 371 Date: Jul. 16, 2009

(51) Int. Cl. G06K 9/46; G06K 9/00

(52) U.S. Cl. 382/100; 382/181; 382/165

(57) ABSTRACT

A method for recognizing fire using block-wise processing of video input provided by a video detector. Video input is divided into a plurality of frames (42), and each frame is divided into a plurality of blocks (44). Video metrics are calculated with respect to each of the plurality of blocks (46), and blocks containing the presence of fire are identified based on the calculated video metrics (74). The detection of a fire is then communicated to an alarm system.

### BACKGROUND OF THE INVENTION

The present invention relates generally to computer vision and pattern recognition, and in particular to video analysis for detecting the presence of fire.

The ability to detect the presence of fire is important on a number of levels, including with respect to human safety and the safety of property. In particular, because of the rapid expansion rate of a fire, it is important to detect the presence of a fire as early as possible. Traditional means of detecting fire include particle sampling (i.e., smoke detectors) and temperature sensors. While accurate, these methods include a number of drawbacks. For instance, traditional particle or smoke detectors require smoke to physically reach a sensor. In some applications, the location of the fire or the presence of ventilated air systems prevents smoke from reaching the detector for an extended length of time, allowing the fire time to spread. A typical temperature sensor requires the sensor to be located physically close to the fire, which means the temperature sensor will not sense a fire until it has spread to the location of the temperature sensor. In addition, neither of these systems provides data regarding size, location, or intensity of the fire.

Video detection of a fire provides solutions to some of these problems. While video is traditionally thought of as visible spectrum imagery, the recent development of video detectors sensitive to the infrared and ultraviolet spectrum further enhances the possibility of video fire detection. A number of video content analysis algorithms are known in the prior art. However, these algorithms often result in problems such as false positives as a result of the video content algorithm misinterpreting video data. Therefore, it would be beneficial to develop an improved method of analyzing video data to determine the presence of a fire.

### BRIEF SUMMARY OF THE INVENTION

Disclosed herein is a method for detecting the presence of fire based on a video input. The video input is comprised of a number of individual frames, wherein each frame is divided into a plurality of blocks. Video analysis is performed on each of the plurality of blocks, calculating a number of video features or metrics. Decisional logic determines, based on the calculated video features and metrics from one or more frames, the presence of a fire.

In another aspect, a video based fire detection system determines the presence of fire based on video input captured by a video detector. The captured video input is provided to a video recognition system that includes, but is not limited to, a frame buffer, a block divider, a block-wise video metric extractor, and decisional logic. The frame buffer stores video input (typically provided in successive frames) provided by the video detector. The block divider divides each of the plurality of frames into a plurality of blocks. The block-wise video metric extractor calculates at least one video metric associated with each of the plurality of blocks. Based on the results of the video metrics calculated with respect to each of the plurality of blocks, the decisional logic determines whether smoke or fire is present in any of the plurality of blocks.

### BRIEF DESCRIPTION OF THE DRAWINGS

FIG. 1 is a functional block diagram of a video detector and video processing system.

FIGS. 2A and 2B illustrate successive frames provided by a video detector, as well as sub-division of the frames into processing blocks.

FIG. 3 is a flowchart of a video analysis algorithm employed by the video processing system in detecting the presence of fire based on data provided by the video detector.

### DETAILED DESCRIPTION

The present invention provides fire detection based on video input provided by a video detector or detectors. A video detector may include a video camera or other video data capture device. The term video input is used generically to refer to video data representing two or three spatial dimensions as well as successive frames defining a time dimension. The fire detection may be based on one-dimensional, two-dimensional, three-dimensional, or four-dimensional processing of the video input. One-dimensional processing typically consists of processing the time sequence of values in successive frames for an individual pixel. Two-dimensional processing typically consists of processing all or part of a frame. Three-dimensional processing consists of processing either all three spatial dimensions at an instant of time or processing a sequence of two-dimensional frames. Four-dimensional processing consists of processing a time sequence of all three spatial dimensions. In general, it is unlikely that full three-dimensional information will be available due to the self-occluding nature of fire and, possibly, limitations on the number of detectors and their respective fields of view. Nevertheless, the techniques taught herein may be applied to full or partial three spatial dimensional data.

For example, in an embodiment employing a two-dimensional processing algorithm, the video input is divided into a plurality of successive frames, each frame representing an instant in time. Each frame may be divided into a plurality of blocks. A video analysis algorithm is applied to each of the plurality of blocks independently, and the result of the video analysis indicates whether a particular block contains the presence of fire. The video analysis includes performing spatial transforms on each of the plurality of blocks, and the result of the spatial transform provides information regarding the texture of the block, which can be compared, e.g., to learned models, to determine whether the detected texture indicates the presence of fire.

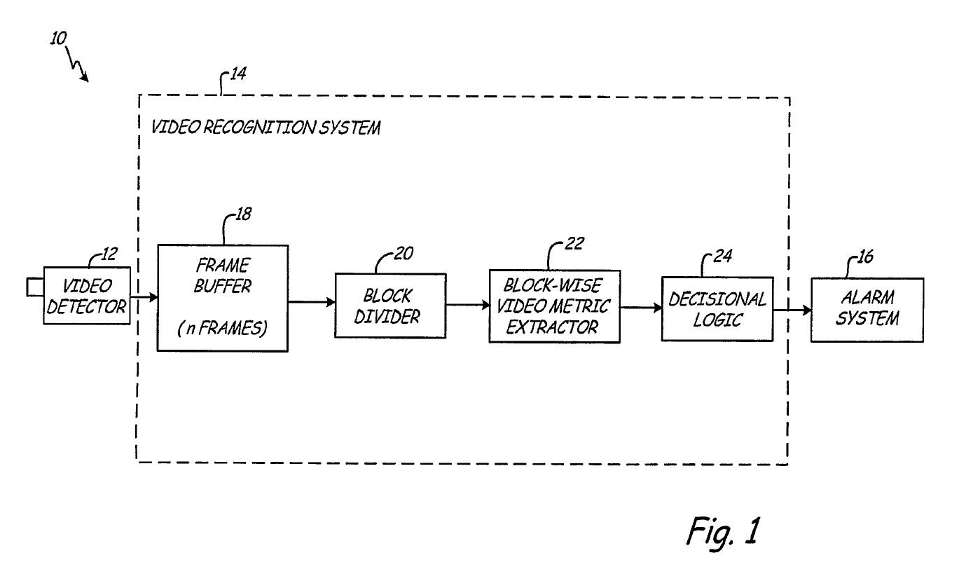

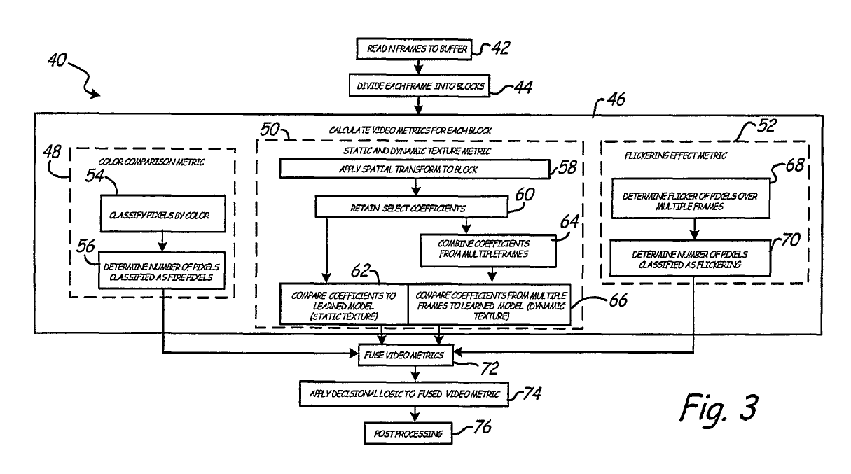

FIG. 1 is a functional block diagram of a fire detection system 10, which includes at least one video detector 12, video recognition system 14 and alarm system 16. Video images captured by video detector 12 are provided to video recognition system 14, which includes hardware and software necessary to perform the functional steps shown within video recognition system 14. The provision of video by video detector 12 to video recognition system 14 may be by any of a number of means, e.g., by a hardwired connection, over a dedicated wireless network, over a shared wireless network, etc. Hardware included within video recognition system 14 includes, but is not limited to, a video processor as well as memory. Software included within video recognition system 14 includes video content analysis software, which is described in more detail with respect to algorithms shown in FIG. 3.

Video recognition system 14 includes, but is not limited to, frame buffer 18, block divider 20, block-wise video metric extractor 22, and decisional logic 24. Video detector 12 captures a number of successive video images or frames. Video input from video detector 12 is provided to frame buffer 18, which temporarily stores a number of individual frames. Frame buffer 18 may retain one frame, every successive frame, a subsampling of successive frames, or may only store a certain number of successive frames for periodic analysis. Frame buffer 18 may be implemented by any of a number of means including separate hardware or as a designated part of computer memory. Frames stored by frame buffer 18 are provided to block divider 20, which divides each of the frames into a plurality of blocks. Each block contains a number of pixels. For instance, in one embodiment block divider 20 divides each frame into a plurality of eight pixel by eight pixel square blocks. In other embodiments, the shape of the blocks and the number of pixels included in each block are varied to suit the particular application.

Each of the plurality of blocks is provided to block-wise video metric extractor 22, which applies a video analysis algorithm (shown in FIG. 3) to each block to generate a number of video features or metrics. Video metrics calculated by block-wise video metric extractor 22 are provided to decisional logic 24, which determines based on the provided video metrics whether each of the plurality of blocks indicates the presence of fire. If decisional logic 24 indicates the presence of fire, then decisional logic 24 communicates with alarm system 16 to indicate the presence of fire. Decisional logic 24 may also provide alarm system 16 with location data, size data, and intensity data with respect to a detected fire. This allows alarm system 16 to respond more specifically to a detected fire, for instance, by directing fire fighting efforts to only the location indicated.

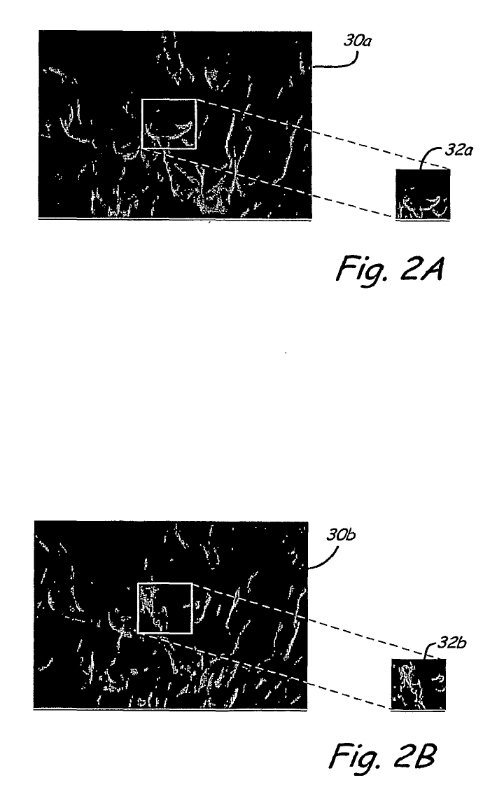

FIGS. 2A and 2B illustrate the division of video frames 30a and 30b respectively into blocks 32a and 32b, respectively. FIGS. 2A and 2B also illustrate a benefit of using block wise processing over other methods. FIG. 2A shows video detector input at time T1 (i.e., first frame 30a) and the location of block 32a within video frame 30a. Similarly, FIG. 2B shows video detector input at time T2 (i.e., second frame 30b) and the location of block 32b within video frame 30b. FIGS. 2A and 2B illustrate a unique feature of fire that makes block wise processing of video frames particularly well suited to detected the presence of fire. Unlike other types of video recognition applications, such as facial recognition, it is not necessary to process an entire frame in order to recognize the presence of fire. For instance, performing video analysis on a small portion of a person's face would not provide enough information to recognize a particular person or even that a person is present. As a result, facial recognition requires the processing of an entire frame (typically constructing a gaussian pyramid of images) that greatly increases the computational complexity. As shown in FIGS. 2A and 2B, this level of computational complexity is avoided in the present invention by providing for block-wise processing.

A unique characteristic of fire is the ability to recognize fire based on only a small sample of a larger fire. For instance, video content algorithms performed on entire video frame 30a or 30b would recognize the presence of fire. However, due to the nature of fire, video content algorithms performed only on blocks 32b and 32b also indicate the presence of fire. This allows video frames 30a and 30b to be divided into a plurality of individual blocks (such as block 30), with video content analysis performed on individual blocks. The benefit of this process is the presence of fire located in a small portion of the video frame may be detected with a high level of accuracy. This also allows the location and size of a fire to be determined, rather than merely binary detection of a fire provided by typical non-video fire alarms. This method also reduces the computational complexity required to process video input. In the embodiment shown in FIGS. 2A and 2B, frames are divided into square blocks, although in other embodiments, blocks may be divided into a variety of geometric shapes, and the size of the blocks may vary from only a few pixels (e.g., 4×4) to a large number of pixels.

FIG. 3 is a flowchart of video processing algorithm 40 employed by video recognition system 14, as shown in FIG. 1, used to recognize the presence of fire. Video processing algorithm 40 may extract a number of video metrics or features including, but not limited to, color, texture, flickering effect, partial or full obscuration, blurring, and shape associated with each of the plurality of blocks.

At step 42, a plurality of frames N are read into frame buffer 18. Each of the plurality of frames N is divided into a plurality of individual blocks at step 44. Video content analysis is performed on each individual block at step 46. Video content analysis, in the embodiment shown in FIG. 3, includes calculation of video metrics or features that are be used either alone or in combination by decisional logic 24 (as shown in FIG. 1) to detect the presence of fire. The video metrics as illustrated include a color comparison metric (performed by algorithm 48), a static texture and dynamic texture metric (performed algorithm 50) and flickering effect metric (performed by algorithm 52).

Color comparison algorithm 48 provides a color comparison metric. At step 54, each pixel within a block is compared to a learned color map with a threshold value to determine if a pixel is indicative of a fire pixel (e.g., if it has the characteristic orange or red color of fire). A color map may capture any desired color characteristics, e.g., it may include blue for certain flammable substances such as alcohol.

In particular, color comparison algorithms are often useful in detecting the presence of fire. Color comparison algorithms operate in either RGB (red, green, blue) color space or HSV (hue, saturation, value) color space, wherein each pixel can be represented by a RGB triple or HSV triple. Distributions representing fire images and non-fire images are generated by classifying each pixel in an image based on an RGB or HSV triple value. For example, a distribution may be built using a non-parametric approach that utilizes histogram bins to build a distribution. Pixels from a fire image (an image known to contain the presence of fire) are classified (based on an RGB or HSV triple value) and projected into corresponding discrete bins to build a distribution representing the presence of fire. Pixels from non-fire images are similarly classified and projected into discrete bins to build a distribution representing a non-fire image. Pixels in a current video frame are classified (based on RGB and HSV values) and compared to the distributions representing fire or smoke images and non-fire images to determine whether the current pixel should be classified as a fire pixel or a non-fire pixel.

In another embodiment, distributions are generated using a parametric approach that includes fitting a pre-assumed mixture of Gaussian distributions. Pixels from both fire images and non-fire images are classified (based on RGB or HSV triples) and positioned in three-dimensional space to form pixel clusters. A mixture of gaussian (MOG) distribution is learned from the pixel clusters. To determine whether an unknown pixel should be classified as a fire pixel or non-fire pixel, the corresponding value associated with the unknown pixel is compared with the MOG distributions representing fire and non-fire images. The use of a color comparison algorithm is described in further detail by the following reference: Healey, G., Slater, D., Lin, T., Drda, B., Goedeke, A. D., 1993 “A System for Real-Time Fire Detection”, IEEE Conf. Computer Vision and Pattern Recognition, p. 605-606.

At step 56, the number of pixels within a block identified as fire pixels or the percentage of pixels identified as fire pixels are provided as a color comparison metric to the fusion block at step 68.

The algorithm shown in block 50 provides a texture analysis metric. In general, a texture analysis is a two-dimensional spatial transform performed over an individual block or a three-dimensional transform over a sequence of blocks that provides space or time-space frequency information with respect to the block. The frequency information provided by the transform describes the texture associated with a particular block. In general, fire tends to have a unique texture, and spatial or time-spatial analysis performed on one or more blocks containing fire provides a recognizable set of time-frequency information, typically with identifiable high frequency components, regardless of the size of the sample.

By dividing each frame into a plurality of blocks, two-dimensional spatial analysis is able to detect fires that only occupy a small portion of each frame. That is, spatial analysis performed on an entire frame may not detect the presence of a small fire within the frame, but block-wise processing of the frame will result in detection of even a small fire.

Tracking textural data associated with a particular block over time provides what is known as dynamic texture data (i.e., the changing texture of a block over time). A block containing fire is characterized by a dynamic texture that indicates the presence of turbulence. Thus, both texture associated with a single block in a single frame (i.e., static texture) and dynamic texture associated with a block over a period of time can be used to recognize the presence of fire in a particular block.

Static texture (spatial two-dimensional texture) and dynamic texture (spatial two-dimensional texture over time) generalize directly to spatial three-dimensional texture and spatial 3-dimensional texture over time, provided that multiple video detectors 14 provide 3-dimensional data at each instant of time (a 3-dimensional frame in frame buffer 18).

At step 58, a spatial transform is performed on each of the individual blocks, where the block may represent two-dimensional or three-dimensional data. The spatial transform, depending on the specific type of transform employed (such as discrete cosine transform (DCT), discrete wavelet transform (DWT), singular value decomposition (SVD)), results in a number of coefficients being provided. At step 60, K coefficients providing information regarding the texture of a particular block are retained for further analysis, and coefficients not providing information regarding texture are removed. For example, the first order coefficient provided by the spatial DCT transform typically does not provide useful information with respect to the texture of a particular block, and so it is discarded. Coefficients K selected at step 60 provide textural information with respect to a single block, possibly in a single frame. In one embodiment, these coefficients are analyzed independently at step 62 to determine if the static texture associated with a particular block is indicative of fire. In another embodiment, analysis at step 62 includes comparing static texture (selected coefficients) from the current frame to static texture coefficients representing blocks known to contain fire. The result of the comparison, the static texture metric, provides an indication of whether or not a particular block contains fire.

In another embodiment, in addition to calculating a static texture metric, a dynamic texture associated with a block (i.e., texture of a block analyzed over time) is calculated separately at step 64. At step 64, the dynamic texture associated with a particular block is calculated. This includes combining the coefficients K associated with a particular block within a first frame with coefficients calculated with respect to the same block in successive frames. For instance, as shown in FIGS. 2A and 2B, a spatial transform performed on block 32a associated with frame 30a at time T1 provides a first set of coefficients. A spatial transform performed on block 32b associated with frame 30b at time T2 (i.e., the next frame) provides a second set of coefficients. At step 64, the first set of coefficients is combined with the second set of coefficients, along with coefficients from previous frames. In one embodiment, the method of combination is to perform a further transformation of the transform coefficients resulting in coefficients of a three-dimensional transformation of the original video sequence. In another embodiment, the coefficients are represented as a vector sequence that provides a method of analyzing the first and second set of coefficients. In still other embodiments, a selected number of coefficients associated with each of a plurality of frames N can be combined (Number of Frames N×Selected Coefficients K).

At step 66, the coefficients K associated with a block as well as the combination of dominant coefficients K associated with a block in a plurality of frames N are compared with learned models to determine if the dynamic texture of the block indicates the presence of fire. The learned model acts as a threshold that allows video recognition system 14 to determine whether fire is likely present in a particular block. In one embodiment, the learned model is programmed by storing spatial transforms of blocks known to contain fire and the spatial transforms of blocks not containing fire. In this way, the video recognition system can make comparisons between spatial coefficients representing blocks in the plurality of frames stored in frame buffer 18 and spatial coefficients representing the presence of fire. The result of the static texture and dynamic texture analysis is provided to fusion block at step 72. While the embodiment shown in FIG. 3 makes use of learned models, any of a number of classification techniques known to one of ordinary skill in the art may be employed without departing from the spirit and scope of this invention.

The algorithm shown in block 52 provides a flickering effect metric. Because of the turbulent motion of characteristic of fires, individual pixels in a block containing fire will display a characteristic known as flicker. Flicker can be defined as the changing of color or intensity of a pixel from frame to frame. Thus, at step 68, the color or intensity of a pixel from a first frame is compared with the color or intensity of a pixel (taken at the same pixel location) from previous frames. The number of pixels containing characteristic of flicker, or the percentage of pixels containing characteristics of flicker is determined at step 70. The resulting flicker metric is fused with other video metrics at step 72. Further information regarding calculation of flicker effects to determine the presence of fire is provided in the following references: W. Phillips, III, M. Shah, and N. da Vitoria Lobo. “Flame Recognition in Video”, In Fifth IEEE Workshop on Applications of Computer Vision, pages 224-229, December 2000 and T.-H. Chen, P.-H Wu, Y.-C. Chiou, “An early-detection method based on image processing”, in Proceedings of the 2004 International Conference on Image Processing (ICIP 2004), Singapore, Oct. 24-27, 2004, pp. 1707-1710.

Other video metrics indicative of fire, such as a shape metric, partial or full obscuration metric, or blurring metric, as are well know in the art, may also be computed without departing from the spirit and scope of this invention. Each of these metrics is calculated by comparing a current frame or video image with a reference image, where the reference image might be a previous frame or the computed result of multiple previous frames. For instance, the shape metric includes first comparing the current image with a reference image and detecting regions of differences. The detected regions indicating a difference between the reference image and current image are analyzed to determine whether the detected region is indicative of smoke or fire. Methods used to make this determination include, but are not limited to, density of the detected region, aspect ratio, and total area. The shape of the defined region may also be compared to models that teach shapes indicative of fire or smoke (i.e., a characteristic smoke plume) to determine whether the region is indicative of smoke.

A partial or full obscuration metric is also based on comparisons between a current image and a reference image. A common method of calculating these metrics requires generating transform coefficients for the reference image and the current image. For example, transform algorithms such as the discrete cosine transform (DCT) or discrete wavelet transform (DWT) may be used to generate the transform coefficients for the reference image and the current image. The coefficients calculated with respect to the current image are compared with the coefficients calculated with respect to the reference image (using any number of statistical methods, such as Skew, Kurtosis, Reference Difference, or Quadratic Fit) to provide an obscuration metric. The obscuration metric indicates whether the current image is either fully or partially obscured, which may in turn indicate the presence of smoke or flames. Likewise, a similar analysis based on calculated coefficients for a reference image and current image can be used to calculate out-of-focus or blurred conditions, which is also indicative of the presence of smoke or flames.

At step 72, the results of the metrics associated with color, texture analysis, and flickering effect (as well as any of the additional video metrics listed above) are combined or fused into a single metric. Metric fusion describes the process by which metrics (inputs) from varying sources (such as any of the metrics discussed above) are combined such that the resulting metric is in some way better or performs better than if the individual metrics were analyzed separately. For example, a metric fusion algorithm may employ any one of the following algorithms, including, but not limited to, a Kalman filter, a Bayesian Network, or a Dempster-Shafer model. Further information on data fusion is provided in the following reference: Hall, D. L., Handbook of Multisensor Data Fusion, CRC Press, 2001.

By combining a number of features, the number of false alarms generated by video recognition systems is greatly reduced. At step 74, the fused metric is provided to decisional logic 24 (shown in FIG. 1), which determines whether a particular block contains fire. Decisional logic 24 at step 74 may make use of a number of techniques, including the comparing of the fused metrics with a maximum allowable fused metric value, linear combination of fused metrics, neural net, Bayesian net, or fuzzy logic concerning fused metric values. Decision logic is additionally described, for instance, in Statistical Decision Theory and Bayesian Analysis by James O. Berger, Springer; 2 ed. 1993.

Post-processing is done at step 76, wherein the blocks identified as containing fire are combined and additional filtering is performed to further reduce false alarms. This step allows the location and size of a fire to be determined by video recognition system 14 (as shown in FIG. 1). A typical feature of uncontrolled fires is the presence of turbulence on the outside edges of a fire, and relatively constant features in the interior of the fire. By connecting blocks identified as containing fire together, video recognition system 14 is able to include in the identification of the fire those locations in the interior of the fire that were not previously identified by the above algorithms as containing fire. In this way, the location and size of the fire may be more accurately determined and communicated to alarm system 16. Additional temporal and/or spatial filtering may be performed in step 76 to further reduce false alarms. For instance, under certain conditions a fire may be predominantly oriented vertically. In such cases, detections with small size and predominantly horizontal aspect ratio may be rejected. Under certain circumstances, it may be desirable to require continuous detection over a period of time before annunciating detection. Detection that persists less than a prescribed length of time may be rejected.

Therefore, a video aided fire detection system has been described that employs block-wise processing to detect the presence of fire. Video input consisting of a number of successive frames is provided to a video processor, which divides each individual frame into a plurality of blocks. Video content analysis is performed on each of the plurality of blocks, the result of the video content analysis indicating whether or not each of the plurality of blocks contains fire.

Although FIG. 3 as described above describes the performance of a number of steps, the numerical ordering of the steps does not imply an actual order in which the steps must be performed.

Although the present invention has been described with reference to preferred embodiments, workers skilled in the art will recognize that changes may be made in form and detail without departing from the spirit and scope of the invention. Throughout the specification and claims, the use of the term “a” should not be interpreted to mean “only one”, but rather should be interpreted broadly as meaning “one or more.”Furthermore, the use of the term “or” should be interpreted as being inclusive unless otherwise stated.

1. A method for performing video analysis to detect presence of fire, the method comprising:
acquiring video data comprised of individual frames (42);
dividing each of the individual frames into a plurality of blocks (44);
calculating a video metric associated with each of the plurality of blocks (46); and
determining whether fire is present based, at least in part, on the calculated video metric associated with each of the plurality of blocks (74).

2. The method of claim 1, wherein calculating a video metric associated with each of the plurality of blocks includes:
applying a spatial transform (58) to each of the plurality of blocks within a particular frame to generate static texture data.

3. The method of claim 2, wherein determining whether fire is present in each of the plurality of blocks includes:
comparing the static texture data generated with respect to each of the plurality of blocks to a static texture model representing fire (62).

4. The method of claim 2, further including:
combining texture data from one of the plurality of blocks over a number of frames over time (64) to generate dynamic texture data.

5. The method of claim 4, determining whether fire is present in each of the plurality of blocks includes:
comparing the dynamic texture data generated with respect to each of the plurality of blocks to a dynamic texture model representing fire (66).

6. The method of claim 1, further including:
connecting together blocks determined to include the presence of fire (76); and
determining whether blocks not identified as containing fire should be identified as fire blocks based on the connected blocks containing fire.

7. The method of claim 1, wherein calculating a video metric associated with each of the plurality of blocks includes:
calculating a first video metric and a second video metric associated with each of the plurality of blocks.

8. The method of claim 7, further including:
combining the first video metric and the second video metric into a combined video metric (72).

9. The method of claim 8, wherein determining whether fire is present in each of the plurality of blocks includes:
applying decisional logic to the combined video metric to determine whether each of the plurality of blocks contains fire (74).

10. The method of claim 7, wherein calculating a first and a second video metric includes:
calculating the first video metric selected from the following: color metric, texture metric, dynamic texture metric, flicker effect metric, obscuration metric, blurring metric, and shape metric; and
calculating the second video metric selected from the following: color metric, texture metric, dynamic texture metric, flicker effect metric, obscuration metric, blurring metric, and shape metric.

11. A video based fire detection system, the system comprising:
at least one video detector (12) for capturing video input; and
a video recognition system (14) connected to receive video input from the video detector (12), wherein the video recognition system (14) includes:
a frame buffer (18) for storing a plurality of frames provided by the video detector (12);
a block divider (20) for dividing each of the plurality of frames into a plurality of blocks;
a block-wise video metric extractor (22) for calculating a video metric associated with each of the plurality of blocks; and
decisional logic (24) for determining based on the video metric whether fire exist in each of the plurality of blocks.

12. The system of claim 11, wherein the block-wise video metric extractor (22) calculates static texture data associated with each of the plurality of blocks in a particular frame.

13. The system of claim 12, wherein the block-wise video metric extractor (22) compares the static texture data calculated with respect to each of the plurality of blocks in the particular frame with learned model static texture data to calculate a static texture metric.

14. The system of claim 13, wherein the static texture metric is provided to the decisional logic (24), which determines whether each of the plurality of blocks indicates the presence of fire.

15. The system of claim 11, wherein the block-wise video metric extractor (22) calculates dynamic texture data associated with each of the plurality of blocks over a number of frames.

16. The system of claim 15, wherein the block-wise video metric extractor (22) compares the dynamic texture data calculated with respect to each of the plurality of blocks over a number of frames with learned model dynamic texture data to calculate a dynamic texture metric.

17. The system of claim 16, wherein the dynamic texture metric is provided to the decisional logic (24), which determines whether each of the plurality of blocks indicates the presence of fire.

18. The system of claim 15, wherein the block-wise video metric extractor (22) calculates a number of video metrics associated with each of the plurality of blocks, including at least one of the following: color metric, static texture metric, dynamic texture metric, flickering effect metric, obscuration metric, blurring metric, and shape metric.

19. The system of claim 11, further including:
a block connector which connects each of the plurality of blocks indicated by the decisional logic as containing fire and determines whether the blocks indicated as not containing fire should be included with the plurality of blocks indicating fire.

20. The system of claim 11, further including:
an alarm system (16) for receiving input form the video recognition system (14) regarding the presence of fire, wherein the video recognition system provides the alarm system with at least one of the following: presence of fire, location of fire, and size of fire.
